(19) United States
(12) Patent Application Publication
(10) Pub. No.: US 2010/0137024 A1
(43) Pub. Date: Jun. 3, 2010

(54) Multi-Mode Radio Frequency Communications

(75) Inventor: Yael G. Maguire, Somerville, MA (US)

Correspondence Address: CHOATE, HALL & STEWART LLP, TWO INTERNATIONAL PLACE, BOSTON, MA, 02110, US

(73) Assignee: THINGMAGIC, INC., Cambridge, MA (US)

(21) Appl. No.: 12/595,444

(22) PCT Filed: Apr. 10, 2008
(86) PCT No.: PCT/US2008/059941

§ 371 Date: Oct. 9, 2009

Related U.S. Application Data
(60) Provisional application No. 60/923,314, filed on Apr. 13, 2007.
(60) Provisional application No. 60/912,871, filed on Apr. 19, 2007.

(51) Int. Cl. H04M 1/00

(52) U.S. Cl. 455/552.1

(57) ABSTRACT

A transceiver circuit includes an input to receive an RF mode control signal, multiple ports, and path circuitry disposed between the multiple ports. The path circuitry can be configured to create different low impedance conductive paths between the multiple ports depending on a state of the RF mode control signal. For example, depending on a mode as specified by the RF mode control signal, the transceiver circuit and corresponding path circuitry enables a half-duplex mode and a full-duplex mode.

### BACKGROUND

Radio technology has long been used to support wireless communications. Based on the evolution of radio technology over the years, it is now possible to communicate via (RF Radio Frequency) in many different ways.

For example, according to current RFID technology, it is possible for a so-called RFID tag reader to communicate with multiple RFID tags in a monitored region. According to another technology such as Bluetooth, it is possible for a computer to implement short-range communications with devices such as cell phones, keyboards, etc. According to yet another technology such as WiFi (e.g., 802.11), it is possible to implement a wireless access point in a home network to support medium range communications between the wireless access point and devices such as computers, televisions, etc.

Certain RFID technology enables RFID tag readers to communicate with passive RFID tags. For example, to support communications with the passive RFID tag reader systems, a tag reader's transmitter and receiver must be simultaneously active. In general, this is because the tag reader's transmitted signal is used to power the tag while the tag, in turn, generates a reply back to the tag reader. If the tag reader does not output an RF signal while listening for a tag's response, the tag reader would not be able to receive data from the tag because the tag will power down, making it unable to respond. Thus, for passive tags, the tag reader must output RF energy during the tag's responses to the reader's commands.

Radio technologies such as WiFi, bluetooth, cellular phones, etc., support communications in a different way than do passive RFID tag readers. For example, WiFi, bluetooth, cellular phones, etc., typically support half-duplex communications in which corresponding radio devices must be configured at different times to either transmit data or receive data. Half-duplex communications do not allow two different radio devices to send radio frequency energy bi-directionally to each other at the same time. For example, to implement half-duplex communications, when a first radio device is in the transmit mode, a second radio device must be set to a receive mode to receive data transmitted by the first radio device. Conversely, when the second radio device is in the transmit mode, the first radio device must be set to a receive mode to receive data transmitted by the second radio device.

As mentioned above, passive RFID tag readers must be able to transmit RF energy at the same time of receiving RF energy from an RFID tag. Thus, it is not possible to communicate with a passive RFID tag using half-duplex energy transfer.

### SUMMARY

Conventional ways of implementing passive RFID technology and half-duplex technology suffer from a number of deficiencies. For example, suppose that a user would like to configure his or her computer to support both RFID technology as well as Bluetooth™ technology. To implement both types of technologies, it would be necessary for the user to purchase and install separate radio systems such as a first radio system to support RFID radio communications and a second system supporting half-duplex communications such as Bluetooth™ communications. In addition to the burdensome cost of having to pay for each of the radio systems, the user would have to spend the time (or pay another person) to install the radio devices on his or her computer. Many of the components in each RF system are duplicative. That is, each system, even though configured to communicate in different ways, includes some of the same RF components.

Embodiments herein include unique ways to implement radio technology capable of supporting multiple types of radio communications such as a combination of passive RFID tag communications as well as half-duplex radio communications.

More specifically, in one embodiment, a transceiver circuit includes an input to receive an RF mode control signal, multiple ports, and path circuitry disposed between the multiple ports. The path circuitry can be configured to create different conductive paths between the multiple ports depending on a state of the RF mode control signal.

As an example, assume that the transceiver circuit includes a first port for coupling the transceiver circuit to an output of a transmitter circuit, a second port for coupling the transceiver circuit to an input of a receiver circuit, and a third port for coupling the transceiver circuit to an RF transducer assembly. Based on selection of a first mode as specified by the RF mode control signal, the path circuitry can be configured to simultaneously provide: i) a conductive path between the transmitter circuit and the RF transducer assembly, and ii) a conductive path between the RF transducer assembly and the receiver circuit. Thus, the transceiver circuit can be configured to support a full-duplex mode in which an RF transducer assembly both transmits RF energy and receives RF energy at the same time.

In one embodiment, when set to the full-duplex mode, the transmitter drives the RF transducer assembly to create a continuous wave RF output signal transmitted into a monitored region to power one or more RFID tags in the monitored region. While also in the full-duplex mode, the RF transducer assembly detects responses by the one or more RFID tags and produces a corresponding electrical signal through the transceiver circuit to the receiver circuit. Accordingly, while the transmitter circuit drives the RF transducer assembly to power the one or more RFID tags, the receiver circuit detects responses by the one or more RFID tags as detected by the RF transducer assembly.

In one embodiment, the RF transducer assembly includes one or more antenna devices for communicating in a monitored region.

Note further that the path circuitry and/or transceiver circuit can be configured to support half-duplex communications such as one or more of: Bluetooth™ communications, 802.11 communications, cellular phone communications, etc. For example, when in a second mode as specified by the mode control signal, the path circuitry in the transceiver circuit can be configured to switch between creating a low impedance conductive path between the first port and the third port to enable the transmitter to drive the RF transducer assembly and creating a low impedance conductive path between the second port and the third port to enable the receiver to receive signals produced by the RF transducer assembly. Thus, in accordance with embodiments herein, path circuitry according to embodiments herein can be configured to toggle between sub-modes of: i) providing a conductive path between the transmitter circuit and the RF transducer assembly, and ii) providing a conductive path between the RF transducer assembly and the receiver circuit. The sub-modes can be non-overlapping in time such that the path circuitry does not provide the conductive path between the transmitter circuit and the RF transducer assembly and the conductive path between the RF transducer assembly and the receiver circuit at the same time.

Accordingly, a transceiver circuit according to embodiments herein can enable half-duplex communications as well as full-duplex communications depending on a respective state of input such as an RF mode control signal. As previously discussed, conventional radio systems implement independently operating radio systems including separate transmitters and receivers. In contrast, according to embodiments herein, a same set of transmitter circuits, receiver circuits, and/or other circuits can be shared between different modes to support different types of communications such as full-duplex and half-duplex operational modes via use of switching circuitry that selectively creates paths amongst ports of the transceiver circuit depending on a selected operational mode. Because the circuitry is shared, implementing a transceiver circuit according to embodiments herein can result in overall reduced circuit costs and a reduced circuit footprint over conventional RF techniques.

In one embodiment, the transmitter circuit includes a modulator in communication with a baseband bus circuit. The receiver can include a demodulator in communication with the baseband bus circuit. The baseband bus circuit can be coupled to a first baseband processing module and a second baseband processing module depending on which mode has been selected.

In further embodiments, the first baseband processing module is configured to manage communications associated with RFID tags. The second baseband processing module is configured to manage half-duplex communications with radio devices that support communications such as Bluetooth™ communications, 802.11 communications, cellular phone communications, etc. Depending on an operational mode of the transceiver circuit (e.g., whether it is in the full-duplex mode or half-duplex mode), the baseband bus circuit switches between connecting the transmitter circuit and the receiver circuit to different basedband circuits.

In accordance with yet further embodiments, the transceiver circuit can include an RF isolation circuit configured to reduce coupling of a signal from a first port and a second port of the transceiver circuit. For example, as previously discussed, the transceiver circuit can include a first port coupled to an output of a transmitter circuit, a second port coupled to an input of a receiver circuit, and a third port coupled to an RF transducer assembly. The RF isolation circuit reduces a level coupling between the transmitter circuit and the receiver circuit when the transceiver circuit is in the full-duplex mode.

Thus, one embodiment herein includes adding RFID read capability to an existing radio communications system such as WiFi/Bluetooth/cellular/WiMax. In such an application, RFID tags can be used as containers of pointers to digital data. An embodiment focuses on containing configuration data for wireless access in a WiFi or Bluetooth or GSM/3G context. All wireless networks have security/access credentials that are entered through synchronized button pushing, wired network, flash drives or manual entry.

Note that the concepts herein can include a passive, semi-passive or active RFID tag for receiving configuration information from a wireless device. The tag stores the information in a location such as non-volatile memory. A user or other devices physically moves the tag to a device (e.g., a computer system) to be configured. The device can include an RFID tag reader for reading this information and configuring itself to be immediately connected. As will be discussed later in this specification, one possible application is multi-user network environments such as a coffee shop where upon payment of a good such as coffee, wireless access can be provided to the purchaser on a time-expired basis without requiring a credit card or other means of access.

Techniques herein are well suited for use in applications such as those supporting communications via use of different types of radio technology. However, it should be noted that configurations herein are not limited to such use and thus configurations herein and deviations thereof are well suited for use in other environments as well.

Note that each of the different features, techniques, configurations, etc. discussed herein can be executed independently or in combination. Accordingly, the present invention can be embodied and viewed in many different ways.

Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details and/or possible perspectives or permutations of the invention, the reader is directed to the Detailed Description section and corresponding figures of the present disclosure as further discussed below.

### BRIEF DESCRIPTION OF THE DRAWINGS

The foregoing and other objects, features, and advantages of the invention will be apparent from the following more particular description of preferred embodiments herein as illustrated in the accompanying drawings in which like reference characters refer to the same parts throughout the different views. The drawings are not necessarily to scale, with emphasis instead being placed upon illustrating the embodiments, principles and concepts.

FIG. 1 is an example diagram of a transceiver circuit according to embodiments herein.

FIG. 2 is an diagram illustrating an example radio system according to embodiments herein.

FIG. 3 is a diagram illustrating an example radio system according to embodiments herein.

FIG. 4 is a diagram illustrating example use of radio system and switching between modes according to embodiments herein.

FIGS. 5-8 illustrate example methods according to embodiments herein.

FIG. 9 is a block diagram of another isolation circuit according to embodiments herein.

FIG. 10 is a block diagram of another isolation circuit according to embodiments herein.

FIG. 11 is a block diagram of controllable impedance and related circuits according to embodiments herein.

FIG. 12 is a block diagram of controllable impedance and related circuits according to embodiment herein.

FIG. 13 is a flow chart illustrating a method of finding a substantially optimal point on a curve according to embodiments herein.

FIG. 14 is a flow chart of an embodiment of a method of executing an algorithm each time an RFID reader hops to a different frequency.

FIG. 15 is an example diagram illustrating an access point according to embodiments herein.

FIG. 16 is an example diagram illustrating a device configured to include a radio system according to embodiments herein.

FIG. 17 is an example diagram illustrating an access point and related devices according to embodiments herein.

### DETAILED DESCRIPTION

As previously discussed, conventional ways of implementing a combination of passive RFID technology and half-duplex technology on the same computer platform suffer from a number of deficiencies. For example, there currently is no solution for communicating with RFID tags and other technology such as WiFi, bluetooth, cellular phones, etc., via an integrated system that provides a combination of these functions. For example, to implement both types of technologies enabling a source such as a computer system to communicate with a number of devices including passive RFID tags, cellular phones, WiFi devices, Bluetooth devices, etc., it would be necessary for a computer user to purchase and install separate RF systems such as a first radio system to support RFID radio communications and a second system supporting half-duplex communications.

Embodiments herein include unique ways to implement radio technology capable of supporting multiple types of radio communications such as a combination of passive RFID tag communications as well as half-duplex radio communications via a unique, integrated RF solution.

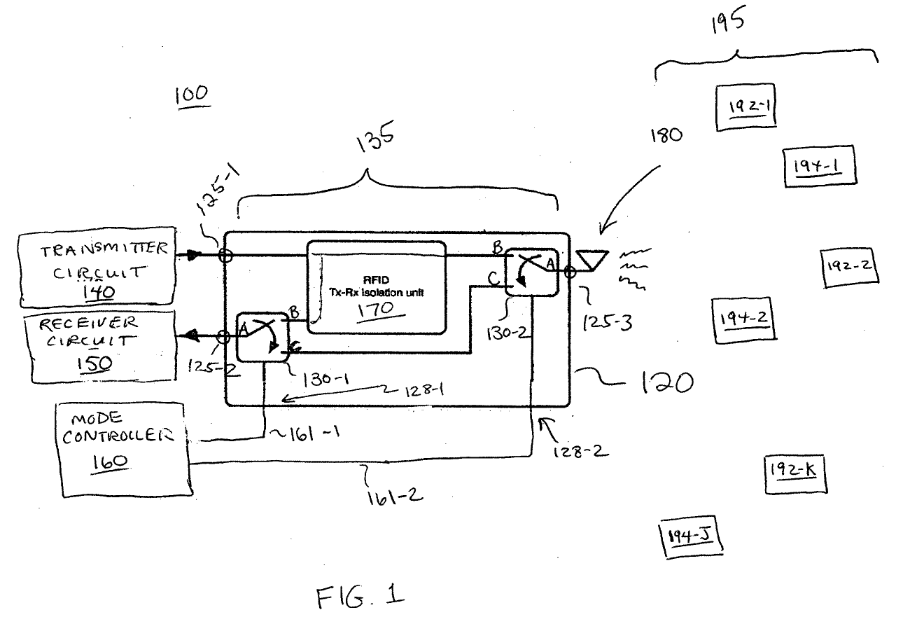

For example, FIG. 1 is an example diagram of a transceiver circuit 120 according to embodiments herein. As shown, transceiver circuit 120 includes one or more input 128 (e.g., input 128-1 and input 128-2) to receive an RF mode control signal 161. In the context of the present example, the RF mode control signal 161 includes signal 161-1 and signal 161-2. Signal 161-1 produced by mode controller 160 controls a state of switch 130-1. Signal 161-2 produced by mode controller 160 controls a state of switch 130-2.

Based on which mode has been selected by mode controller 160, the transceiver circuit 120 can enable different types of communications with target devices such as remote devices 192 (collectively, remote device 192-1, remote device 192-2, . . . , remote device 192-K) and remote devices 194 (collectively, remote device 194-1, remote device 194-2, . . . , remote device 194-J).

By way of a non-limiting example, remote devices 192 can include one or more types of RF devices such as passive RFID tags. Remote devices 194 can include one or more different types of RF devices such as cellular phones, WiFi devices, Bluetooth devices, etc.

As discussed in more detail below, during operation, mode controller 160 selects between multiple different modes for communicating with either remote devices 192 or remote devices 194.

Transceiver circuit 120 also includes multiple ports such as port 125-1, port 125-2, and port 125-3. The path circuitry 135 disposed between ports 125 can be configured to create different low impedance conductive paths between the multiple ports 125 depending on a state of the RF mode control signal 161 as produced by mode controller 160.

As shown in this example, assume that the transceiver circuit 120 includes: port 125-1 for coupling the transceiver circuit 135 to an output of transmitter circuit 140, port 125-2 for coupling the transceiver circuit 120 to an input of receiver circuit 150, and port 125-3 for coupling the transceiver circuit 120 to RF transducer assembly 180.

RF transducer assembly 180 according to embodiments herein includes one or more transducer devices. In one embodiment, the RF transducer assembly 180 is based on MIMO (Multiple In Multiple Out) transducer technology. In such an embodiment, system 100 can include multiple transmitters and multiple receivers instead of just a single transmitter and receiver. The transceiver circuit 120 can connect the multiple transmitters and/or multiple receivers to a set of transducers depending on a selected mode. When in the half-duplex mode, the transceiver circuit 120 can enable multiple 802.x and WiMax communications using multiple transmitters and receivers coupled to multiple transducer elements of RF transducer assembly 180.

In one direction, RF transducer assembly 180 converts one or more received electrical signal into corresponding RF signals for transmission in monitored region 195. The RF transducer assembly 180 converts the received electrical signal into an RF signal for transmission in the monitored region 195. In this instance, the RF signal transmitted by RF transducer assembly 180 may or may not include modulated or encoded data for transmission in monitored region 195.

In the opposite direction, RF transducer assembly 180 detects RF signals present in monitored region 195. In this latter instance, the RF transducer assembly 180 converts the received RF signal into an electrical signal. Note that the received signal may or may not include modulated data.

According to one embodiment, the transmitter circuit 140 in communication system 100 has the ability to generate an electrical signal for driving RF transducer assembly 180. The signal generated by the RF transducer assembly 180 may or may not include encoded data as mentioned above.

For example, at certain times as will be discussed in more detail below, the transmitter circuit 140 drives RF transducer assembly 180 with a signal of modulated data. For example, the transmitter circuit 140 communicates data to remote devices 192 in the monitored region 195.

At other times, the transmitter circuit 140 drives RF transducer assembly 180 with a signal without modulated or encoded data. In this latter instance, the signal generated by the RF transducer assembly 180 is used to drive the RF transducer assembly 180 for purposes of powering remote devices 192 such as passive RFID tags so that they are able to transmit respective wireless responses back to the RF transducer assembly 180 through transceiver circuit 120 to transmitter circuit 150.

The receiver circuit 150 in communication system 100 has the ability to receive electrical signals such as those produced by RF transducer assembly 180 depending on a state of the RF mode control signal 161.

More specifically, note again that the path circuitry 135 is controlled to provide connectivity such as low or high impedance connectivity between transmitter 140 and RF transducer assembly 180 (so that the transmitter circuit 140 can control the output of an RF signal in monitored region 195) as well as low or high impedance connectivity between RF transducer assembly 180 and receiver circuit 150 (so that the receiver circuit 150 can monitor the presence of RF signals by remote devices in monitored region 195).

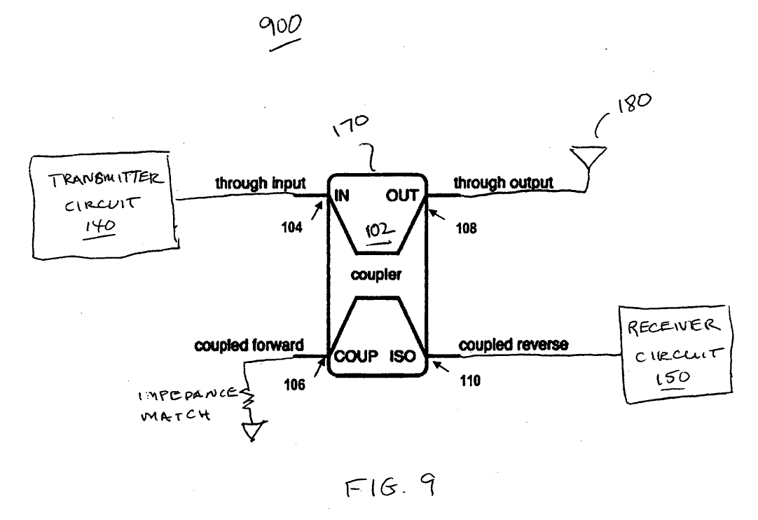

In one embodiment, the transceiver circuit 120 includes an RF isolation circuit 170 as shown. The RF isolation circuit reduces coupling between port 125-1 and port 125-2 of the transceiver circuit 120. For example, as previously discussed, the transceiver circuit can include a port 125-1 coupled to an output of transmitter circuit 140, port 125-2 coupled to an input of receiver circuit 140, and a port 125-3 coupled to RF transducer assembly 180. The RF isolation circuit 170 reduces a level coupling between the transmitter circuit 140 and the receiver circuit 150 when the transceiver circuit 120 is in the full-duplex mode such as when the RF mode control signal 161-1 drives switch 130-1 so that port A and port B are connected and when the RF mode control signal 161-2 drives switch 130-2 so that port A and port B are connected. More details of an example of isolation circuit 170 are shown and discussed with respect to FIGS. 9-14 below.

To select a so-called full-duplex mode, the mode controller 160 produces RF mode control signal 161 to: i) provide a connection such as a low impedance path between port A and port B of switch 130-1, and ii) provide a connection such as a low impedance path between port A and port B of switch 130-2. During such a condition, the switch 130-1 and switch 130-2 provide high impedance paths between respective ports A and ports C. In other words, when in the full-duplex mode, switch 130-1 provides a high impedance path between port A and port C. Switch 130-2 provides a high impedance path between port A and port C.

Based on selection of the first mode (such as a so-called full-duplex mode) as specified by the RF mode control signal 161, the path circuitry 135 in transceiver circuit 120 can be configured to simultaneously provide: i) a first conductive path between the transmitter circuit 140 through RF isolation circuit 170 to the RF transducer assembly 180, and ii) a second conductive path between the RF transducer assembly 180 through the RF isolation circuitry 170 back to the receiver circuit 150.

The first conductive path enables the transmitter circuit 140 to drive the RF transducer assembly 180 and produce an RF signal for transmission in monitored region 195. The second conductive path enables the receiver circuit 150 to receive signals produced by the RF transducer assembly 180. Accordingly, when so configured, the output of transmitter circuit 150 can control generation of RF signals in monitored region 195. The input of receiver circuit 140 can monitor RF signals produced by remote devices 192 in monitored region 195.

Thus, according to embodiments herein, the transceiver circuit 120 can be configured to support a so-called full-duplex mode in which the RF transducer assembly 180 both transmits RF energy in monitored region 195 as well as receives RF energy from 180 at the same time. As previously discussed, transmission of RF energy and detection of RF energy may or may not include transmitting of detecting modulated or encoded data.

Thus, use of the term full-duplex mode in the subject application does not always require that the RF signal transmitted or outputted from RF transducer assembly 180 actually include any encoded data. As previously discussed, the RF signal generated by RF transducer assembly 180 may be transmitted for purposes of powering remote devices 192 such as RFID tags in the monitored region 195.

When set to the full-duplex mode as specified by mode controller 160, the transmitter circuit 140 drives the RF transducer assembly 180 to create a continuous wave RF output signal transmitted in monitored region 195 to power one or more RFID tag in the monitored region 195. While also in the full-duplex mode, as indicated above, the RF transducer assembly 180 detects responses by the one or more RFID tags and produces a corresponding electrical signal through the transceiver circuit 120 to the receiver circuit 150. Accordingly, while the transmitter circuit 140 drives the RF transducer assembly 180 to power the one or more RFID tags such as remote devices 192, the receiver circuit 150 monitors responses by the one or more RFID tags based on the electrical signal received from the RF transducer assembly 180.

Accordingly, communication system 100 can be configured to communicate in accordance with a full-duplex mode to support communication with remote devices such as passive RFID tags.

Note further that the path circuitry 135 and/or transceiver circuit 120 can be configured to support other types of communicates such as half-duplex communications. For example, the half-duplex communications can include one or more of the following types of communications: Bluetooth™ communications, 802.11 communications, cellular phone communications, etc.

To select a half-duplex mode, the mode controller 160 sets a state of RF mode control signal 161-1 to provide a low impedance path between port A and port C of switch 130-1 and a high impedance path between port A and port B of switch 130-1.

The half-duplex mode has two sub-modes as a result of toggling a state of RF mode control signal 161-2 so that switch 130-2 switches between connecting port A to port B (e.g., sub-mode A) and connecting port A to port C (e.g., sub-mode B).

Based on creation of a conductive path between port 125-1 and port 125-3 during sub-mode A of the half-duplex mode, the transmitter circuit 140 is able to drive RF transducer assembly 180 and produce an RF output in monitored region 195. Conversely, based on creation of a conductive path between port 125-2 and port 125-3 during sub-mode B of the half-duplex mode, the receiver circuit 150 is able to monitor RF transducer assembly 180 and detect a presence of RF responses by the remote devices.

More specifically, when in the half-duplex mode as specified by the RF mode control signal 161, the path circuitry 135 in the transceiver circuit 120 is configured to switch between: i) creating a low impedance conductive path between port 125-1 and port 125-3 to enable the transmitter circuit 140 to drive the RF transducer assembly 180 for a first duration and ii) creating a low impedance conductive path between the second port and the third port to enable the receiver circuit 150 to receive signals produced by the RF transducer assembly 180 for a subsequent duration.

Thus, in accordance with embodiments herein, path circuitry 135 can be configured to toggle between half-duplex sub-modes of: i) providing a conductive path between the transmitter circuit 140 and the RF transducer assembly 180, and ii) providing a conductive path between the RF transducer assembly 180 and the receiver circuit 150.

In one embodiment, the sub-modes of the half-duplex mode are non-overlapping in time such that the path circuitry 135 provides a high impedance path between the transmitter circuit 140 and the RF transducer assembly 180 when there is a low impedance path between the RF transducer assembly 180 and the receiver circuit 150. Conversely, the sub-modes of the half-duplex mode are non-overlapping in time such that the path circuitry 135 provides a low impedance path between the transmitter circuit 140 and the RF transducer assembly 180 when there is a high impedance path between the RF transducer assembly 180 and the receiver circuit 150. Enabling communications in a single direction at a time reduces interference between transmit and receive sub-modes. Given that the ratio of transmitter leakage to RFID signal into the receiver can be as high as 75-95 dB, note that the switches used in this system offer a high amount of isolation such as (>75 dB).

In summary, a transceiver circuit 120 according to embodiments herein can enable half-duplex communications as well as full-duplex communications depending on a respective state of input 128 such as an RF mode control signal 160 as produced by a source such as mode controller 160.

As previously discussed, implementation of conventional radio systems requires use of independently operating radio systems to support both a half-duplex modulate and a full-duplex mode as described herein. In such circumstances, the conventional systems do not afford shared use of a transmitter circuit 140 and receiver circuit 150 (as well as other circuitry) as is possible according to novel embodiments herein.

In one embodiment, the transceiver circuit 120 (e.g., a Tx/Rx port matrix or switch) supports two functions, shown in more detail below. The first function is to act like a normal communications device where the transmit and receive ports are not simultaneously active and the second mode is to have the transmitter on in CW mode and the receiver fully active. It may not be favorable to always operate in this mode since the noise figure of the receiver will then be degraded for half-duplex communications.

In the communications mode, port 125-3 has losses relative to the source port 125-1 that must be very small (˜0 dB) so as not to lose precious transmit power. If the losses through the isolation unit 170 is too high, then an alternative topology which favors the transmitter circuit 140 may be used.

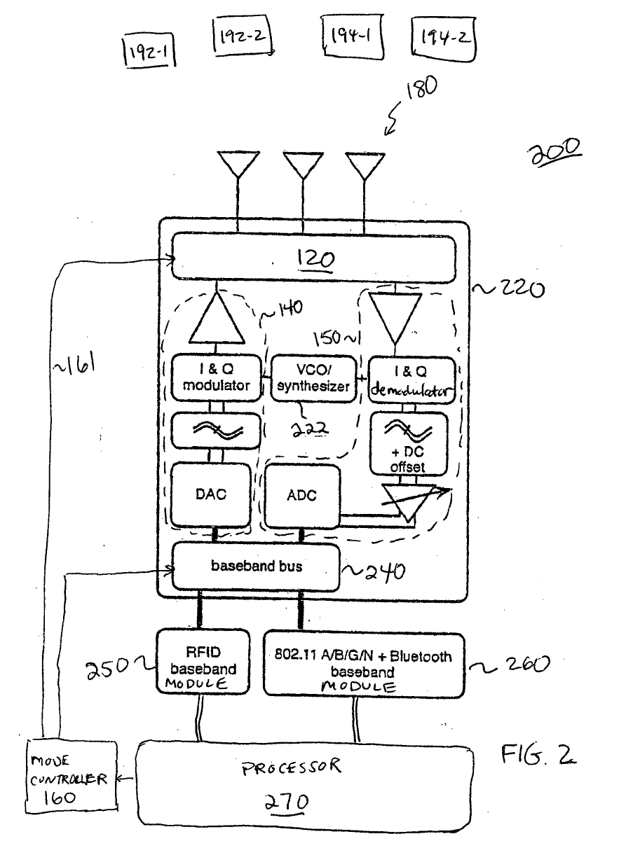

FIG. 2 is an example diagram illustrating communication system 200 including a radio system 220 for communicating with multiple different types of remote devices according to embodiments herein. Radio system 220 can operate at a frequency such as around 2.4 GHz.

As shown, the transmitter circuit 140 includes an amplifier, an I & Q modulator, filter circuitry, and a digital to analog converter circuit. Receiver circuit 150 includes a receiver, an I and Q demodulator, filtering and offset circuitry, and an analog to digital converter circuit. Voltage controlled oscillator 222 controls parameters of both the I and Q modulator and the I and Q demodulator.

Baseband module 250 and baseband module 260 represent any hardware and software functionality to support communications according to embodiments herein. Baseband bus circuit 240 enables either baseband module 250 or baseband module 260 to drive transmitter circuit 150 and receiver circuit 140.

During operation, the baseband bus circuit 240 provides selective connectivity between baseband module 250 and the digital-to-analog converter of transmitter circuit 140 and the analog to digital converter of receiver circuit 150 depending on whether the mode controller 160 selects the full-duplex mode or the half-duplex mode as discussed above. The baseband bus circuit 240 also provides selective connectivity between baseband module 260 and the digital to analog converter of transmitter circuit 140 and the analog to digital converter of receiver circuit 150 depending on whether the mode controller 160 selects the full-duplex mode or the half-duplex mode.

For example, in the full-duplex mode, the baseband bus circuit 240 connects the baseband module 250 to the digital-to-analog converter of transmitter circuit 140 and connects the baseband module 250 to analog to digital converter of receiver circuit 150. In such a mode and as mentioned above, the baseband module 250 can drive transmitter circuit 140 to initiate generation of RF energy in monitored region 195 to communicate with and power remote devices 192 as well as receive responses from remote devices 192 via receiver circuit 150.

For example, in the half-duplex mode, the baseband bus circuit 240 connects the baseband module 260 to digital to analog converter of transmitter circuit 140 and connects the baseband module 250 to analog to digital converter of receiver circuit 150. In such a mode and as mentioned above, the baseband module 260 can drive transmitter circuit 140 to initiate generation of RF energy in monitored region 195 to communicate with and power remote devices 194 as well as receive responses from remote devices 194 via receiver circuit 150. However, because the baseband module 260 supports half-duplex communications, only one of the transmitter circuit 140 and receiver circuit 150 is active at a time supporting communications with remote devices 194.

Thus, depending on an operational mode of the transceiver circuit 120 (e.g., whether it is in the full-duplex mode or half-duplex mode), the baseband bus circuit 240 switches between connecting the transmitter circuit 140 and the receiver circuit 150 to different baseband modules.

With a transmitter CW signal enabled during a tag backscatter response and a direct conversion receiver, a DC offset is always created in the receiver. To maintain proper dynamic range of the system, this DC offset must be removed via some mechanism. Normally, this mechanism is accomplished with a high pass (AC-coupling) or band pass discrete filter network between the RF mixer (IQ modulator (2)) and the IF AGC element (4). When the transceiver is modulating the RF to communicate with a tag, this modulation will produce transients in the receiver which can interfere with the tag response. It is important to make sure the poles and zeros of this IF receive filter (3) are chosen to be appropriate for RFID use. Most other communications systems also have AC-coupling and DC removal circuits for direct conversion receivers, but special consideration will be required to make sure that the time-constants and bandwidth of both types can be accommodated. The ability to switch between two sets of pole-zero filters (one for the traditional communication system, and another for the RFID system) may be required.

For multiple regional operation, strict spectral masks are often required for the transmitter to ensure a minimum amount of interference with legacy applications. In the GSM standard for cellular phones, this is common and requires that the noise produced by the carrier be small enough to accommodate a tight spectral mask. There are at least two types of noise from the transmitter—amplitude (AM) and phase (PM) noise. Usually, AM noise is limited if the digital-to-analog converter (DAC) output is clamped to a particular value, but can be quite large if not. Phase noise is largely a property of the VCO synthesizer. Particular consideration of the type of DAC used and the VCO phase noise will need to be considered in adding RFID to a chip design. One technique employed to improve phase noise is to increase the current into the VCO/synthesizer circuit. Given that the power consumption should not increase for the traditional communications, a switchable current supply may be required to make the tradeoff between phase noise and current consumption.

Finally, the baseband bus (6) may need special consideration. In the event that the radio is capable of communicating both protocols simultaneously, the converter samples may be required to be split or combined depending on the path taken. Furthermore, whether simultaneous or sequential, the converters (ADC and DAC) may operate at different rates. For example, 802.11n can operate at a maximum rate of about 250 mbps, bluetooth 2.1 EDR can operate at 3 mbps, while while the Gen2 RFID standard can only operate at 640 kbps.

If the two integrayed baseband systems share the same converters (which is not a necessity), then rate converters can operate at the highest possible Nyquist rate. To avoid huge oversampling ratios, the data may be decimated or upconverted to allow for efficient filtering techniques.

In one embodiment, the baseband module 250 is configured to manage communications associated with remote devices 192 such as RFID tags. The baseband module 260 is configured to manage half-duplex communications with radio devices 194 that support communications such as Bluetooth™ communications, 802.11 A/B/G/N communications, cellular phone communications, WiMax, etc.

Processor 270 such as a computer system can be configured to generate mode control signals to select between full-duplex and half-duplex communications, control baseband bus circuit 240, provide data for transmitting in the monitored region 195, process received data, etc. Accordingly, a computer system can be equipped with an RF communication system enabling communications with multiple types remote RF devices.

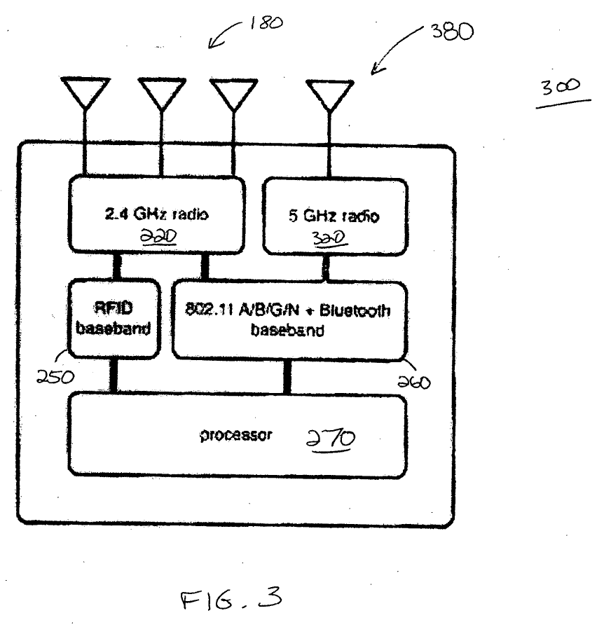

FIG. 3 is an example diagram illustrating communication system 300 according to embodiments herein. As shown, communication system 300 includes radio system 220, baseband module 250, baseband module 260, and processor 270 that operate in manner as previously discussed. Note, however, that communication system 300 can be configured to include an additional radio system 320 for supporting RF communications in a similar manner as discussed above for radio system 220. Radio system 220 can operate around 2.4 GHz. Radio system 320 can operate around 5 GHz. In such an embodiment, radio system 220 supports communications such as bluetooth, 802.11 B/G/N. Radio system 320 supports communications such as 802.11 A/N. Also, in such an embodiment, RF transducer assembly 180 supports 2.4 GHz communications while RF transducer assembly 380 supports 5 GHz communications.

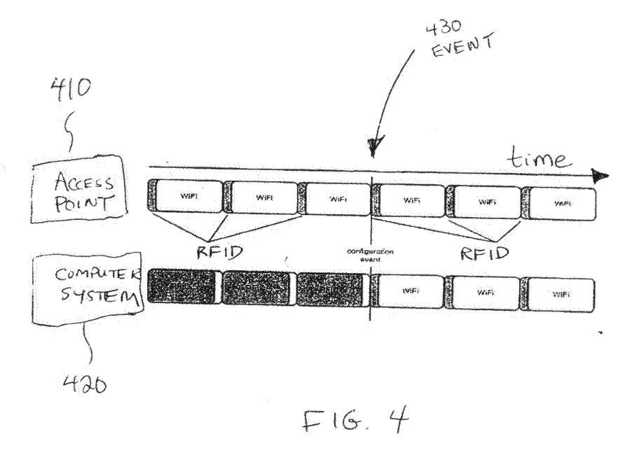

FIG. 4 is an example diagram illustrating scheduling of different communication modes according to embodiments herein. As shown, schedulers associated with computer system 420 and access point 410 can initially allocate different portions of time for monitoring and communicating with RFID tags and communicating with WiFi or bluetooth devices. For example, the access point 410 can allocate a majority of its time in a beacon/discovery mode.

The computer system 420, when first turned on, may not have discovered any remote devices yet so it allocates most of its schedule for monitoring a region for RFID tags and a small portion of time to send beacons in the monitored regions. The RFID tags can indicate how to configure the computer system 420. After the computer system 420 becomes discovered by the access point 410 as indicated by event 430, the computer system 420 can be configured to allocate a greater amount of time to support WiFi, bluetooth, etc., communications rather than RFID tag communications.

More specifically, prior to event 430, the computer system 420 allocates 90% of a schedule to support communications with remote devices 192 such as RFID tags using a full-duplex mode as discussed above. The other 10% of the schedule could be used to support half-duplex communications such as WiFi, bluetooth, cellular phone, etc.

After the event 430, the computer system 420 allocates 10% of a schedule to support communications with remote devices 192 such as RFID tags using a full-duplex mode as discussed above. The other 90% of time would be used to support half-duplex communications such as WiFi, bluetooth, cellular phone, etc.

Of course, the amount of time apportioned to each mode can change depending on current needs of computer system 420.

Also, note that one embodiment herein supports interlacing of communications according to the different communications modes. For example, a communication, transaction, command, etc. may require a number of steps. In certain cases, there is or may be a lag between one step and another. Interlacing of communications can include switching between the full-duplex mode and half-duplex mode to carry out communications in a more efficient manner.

As an example, assume that transaction A includes steps A1, A2, and A3 and will be executed in the half-duplex mode. Assume that transaction B includes steps B1, B2, B3, and B4 and will be executed in the full-duplex mode.

According to embodiments herein, the mode controller can configure the transceiver circuit 120 in the half-duplex mode to enable execution of step A1. After execution of A1, the mode controller 160 can switch the transceiver circuit 120 to the full-duplex mode for execution of steps B1 and B2. Thereafter, the mode controller can switch the transceiver circuit 120 to the half-duplex mode for execution of step A2. Thereafter, the mode controller can switch the transceiver circuit 120 to the full-duplex mode for execution of step B3 and B4. Finally, the mode controller can switch the transceiver circuit 120 back to the full-duplex mode for execution of step A3.

### Sequential Operation of Radios

Since passive RFID tags can misinterpret information from an RF field that is at the same frequency as a reader, it may be useful that a portion of the multi-modal, bi-directional communication system such as 802.11a/b/g/n or Bluetooth not be communicating at the same time as a reader trying to communicate with a tag in monitored region 195. Therefore since frequency diversity is not possible, time diversity is an option for being able to communicate with bi-directional communication radios and RFID tags in a pseudo-simultaneous manner.

The most basic implementation of this system from a conceptual perspective has two distinct radio functionalities combined in a single chip solution. For example, a first radio functionality enables communication with one or more different types of RFID tags (e.g., passive tags, active tags, etc.). A second radio functionality enables traditional communications transceiver such as Bluetooth or 802.11 a/b/g/n. A controller can be used to time sequence the operation of the RFID reader so that they are used efficiently and optimally as will described later in the text. In certain modes, the solution as described herein enables interlacing of communications including powering and communicating with passive RFID tags as well as bi-directional communications with other devices using Bluetooth technology, WIFI technology etc.

For systems that would like to add RFID at low incremental cost, that is, with as small a burden in silicon area as possible, an optimization can be made considering the fact that the communications transceiver and RFID transceiver can share functions such as quadrature up- and downconverters and samplers at the same frequency.

### TDMA Operation

The simplest mode of operation is to operate the device in two modes of operation, which have a constant duty cycle between the two radio modes. The parameters of these modes can be configurable. Note further that it is possible to configure radios system 200 to embed further subdivisions of radio modes within part of an operation mode using recursion.

The operational modes can be divided by the operational modes of WiFi or Bluetooth: discovery and operation. In the discovery mode, the proportion of time allocated to an RFID reader should be relatively high to allow rapid recognition of a configuration tag.

An example of this is shown for two devices (e.g., computer system or other device 420 and access point 410) that each have installed a WiFi radio communication system and a shared 2.4 GHz RFID solution as well. The access point 410 connects to a wide area network such as cable, DSL, or fiber in a home.

The computer system 420 or other device communicates wirelessly to the access point 410 in a WLAN. In the discovery phase of this transaction for the computer 420, the access point 410 may be communicating with existing wireless devices, so a beacon frame, typically around 100 ms, supplies the SSID from the access point 410. The access point 410 must spend a small amount of time operating as an RFID radio since it should spend most of it's time doing beacons and communicating data. (There may be opportunities during exponential back-off or during the beacon itself to use this time for RFID as well.)

The situation is different for the computer system 420 as it has two phases: the first phase is the discovery phase where it must look for beacon frames from the access point 410 to know how to connect; and the second phase is the data phase, where it participates in IP communications with the rest of the devices on the WLAN.

In the data mode, or in normal operation, it is not desirable for the reading operation to significantly lower the data rate of the communications protocol, and so, the duty cycle of this mode may be similar to that of the access point 410 in the data plus beacon mode. In the Generation 2 spec from EPC Global, the time to read an RFID tag can take up to 10 ms in normal modes of operation. If this was done with 5% duty cycle for example, relative to the communications protocol, this would allow an attempt to read a tag once every 200 ms, responsive for most types of user interaction.

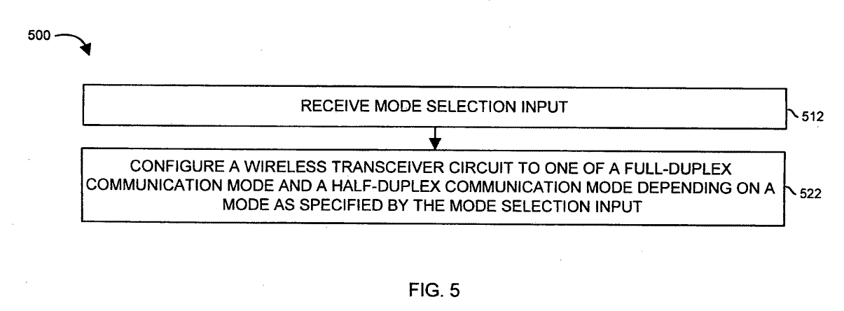

FIG. 5 is a flowchart 500 illustrating a method according to embodiments herein. Note that flowchart 500 of FIG. 5 and corresponding text below will make reference to matter previously discussed with respect to FIGS. 1-4. Note that there will be some overlap with respect to concepts discussed above for FIGS. 1 through 4. Also, note that the steps in the below flowcharts need not always be executed in the order shown. In step 512, the transceiver circuit 120 receives mode selection input from mode controller 160.

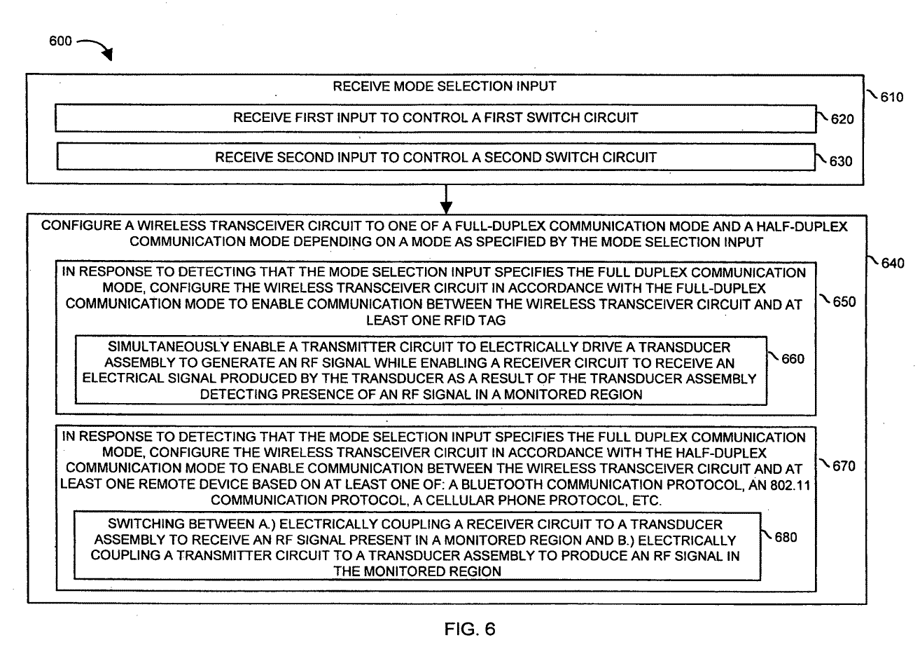

In step 522, the transceiver circuit 120 configures itself to one of a full-duplex communication mode and a half-duplex communication mode depending on a mode as specified by the mode selection input. FIG. 6 is a flowchart 600 illustrating a technique of implementing a transceiver circuit according to embodiments herein. Note that flowchart 600 of FIG. 6 and corresponding text below will make reference to matter previously discussed with respect to FIGS. 1-5.

In step 610, the transceiver circuit 120 receives mode selection input from a source such as mode controller 160.

In sub-step 620, the transceiver circuit 120 receives first input such as RF mode control signal 161-1 to control switch circuit 130-1.

In sub-step 630, the transceiver circuit 120 receives second input such as RF mode control signal 161-2 to control switch circuit 130-2.

In step 640, based on the input, the transceiver circuit 120 configures itself to one of a full-duplex mode and a half-duplex mode depending on a mode as specified by the RF mode control signal 161.

In sub-step 650 of step 640, in response to detecting that the mode selection input specifies the full duplex communication mode, the transceiver circuit 120 configures itself in accordance with the full-duplex communication mode to enable communication between the wireless transceiver circuit and at least one RFID tag such as a remote devices 192 in monitored region 195.

In sub-step 660 of sub-step 650, the transceiver circuit 120 simultaneously enables transmitter circuit 140 to electrically drive RF transducer assembly 180 to generate an RF signal in monitored region 195 while enabling a receiver circuit 150 to receive an electrical signal produced by the RF transducer assembly 180 as a result of the RF transducer assemble 180 detecting presence of an RF signal in a monitored region 195.

In sub-step 670 of step 640, in response to detecting that the mode selection input such as RF mode control signal 161 specifies the full duplex communication mode, the transceiver circuit 120 configures itself in accordance with the half-duplex communication mode to enable communication between the transceiver circuit 120 and at least one remote device 194 based on at least one of: a Bluetooth communication protocol, an 802.11 communication protocol, a WiMax protocol, a cellular phone protocol, etc.

In sub-step 680 of sub-step 670, the transceiver circuit 120 switches between a.) electrically coupling receiver circuit 150 to an RF transducer assembly 180 to receive an RF signal present in a monitored region 195 and b.) electrically coupling transmitter circuit 140 to a RF transducer assembly 180 to produce an RF signal in the monitored region 195.

Accordingly, embodiments herein include switching between a so-called full-duplex mode and a so-called half-duplex mode for communicating with different types of remote devices in a monitored region 195.

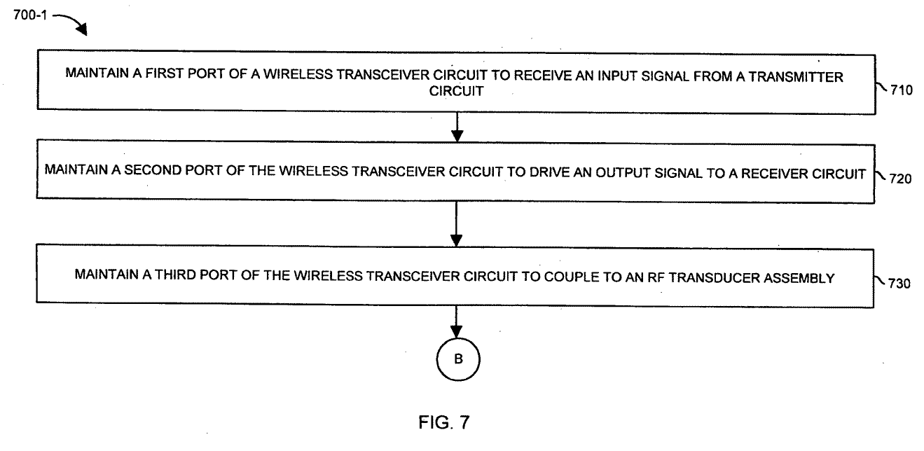

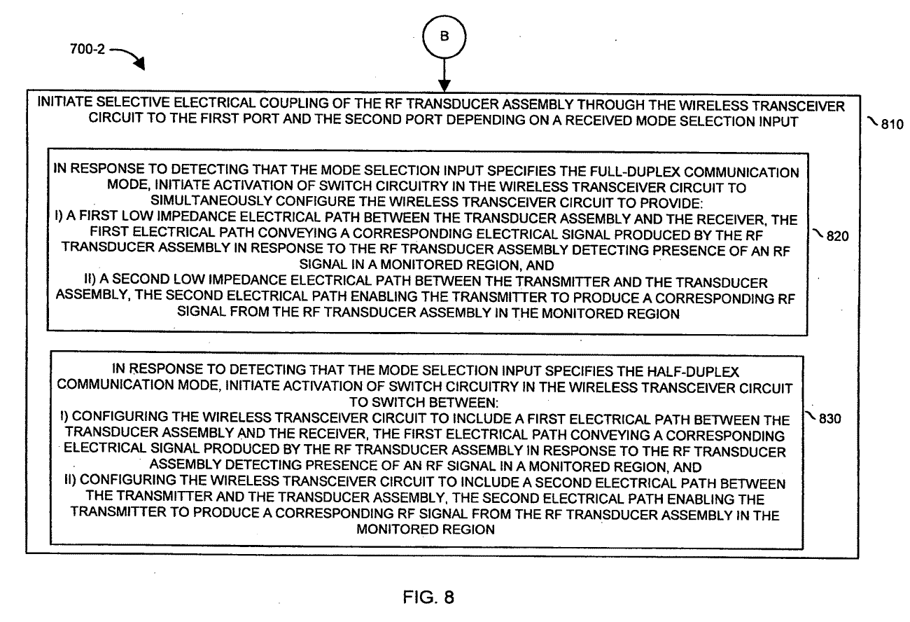

FIGS. 7 and 8 combine to form a flowchart 700 (e.g. flowchart 700-1 and flowchart 700-2) illustrating a technique of implementing a transceiver circuit according to embodiments herein. Note that flowchart 700 and corresponding text below will make reference to matter previously discussed above.

In step 710, the transceiver circuit 120 includes or maintains port 125-1 of transceiver circuit 120 to receive an input signal from transmitter circuit 140.

In step 720, the transceiver circuit 120 includes or maintains port 125-2 of the transceiver circuit 120 to drive an output signal to receiver circuit 150.

In step 730, the transceiver circuit 120 includes or maintains port 125-3 of the transceiver circuit 120 to couple to an RF transducer assembly 180.

In step 810, via path circuitry 135, the transceiver circuit 120 initiates selective electrical coupling of the RF transducer assembly 180 through the transceiver circuit 120 to port 125-1 and port 125-2 depending on received mode selection input as specified by RF mode control signal 161. In sub-step 820 of step 810, in response to detecting that the mode selection input specifies the full-duplex communication mode, the transceiver circuit 120 initiates activation of switch circuitry such as switch circuit 130-1 and switch 130-2 in the transceiver circuit 120 to simultaneously configure the path circuitry 135 of transceiver circuit 120 to include: i) a first electrical path between the RF transducer assembly 180 and the receiver circuit 150, the first electrical path conveying a corresponding electrical signal produced by the RF transducer assembly in response to the RF transducer assembly detecting presence of an RF signal in a monitored region 195, and

ii) a second electrical path between the transmitter circuit 140 and the RF transducer assembly 180, the second electrical path enabling the transmitter to circuit 140 to produce a corresponding RF signal from the RF transducer assembly 180 in the monitored region 195.

In sub-set 830 of step 810, in response to detecting that the mode selection input such as RF mode control signal 161 specifies the half-duplex communication mode, the transceiver circuit 120 initiates activation of switch circuitry such as switch circuit 130-1 and switch circuit 130-2 in the transceiver circuit 120 to switch between: i) configuring the path circuitry 135 of transceiver circuit 120 to include a first electrical path between the RF transducer assembly 180 and the receiver circuit 150, the first electrical path conveying a corresponding electrical signal produced by the RF transducer assembly 180 in response to the RF transducer assembly 180 detecting presence of an RF signal in a monitored region 195, and

ii) configuring the path circuitry 135 of transceiver circuit 120 to include a second electrical path between the transmitter circuit 140 and the RF transducer assembly 180, the second electrical path enabling the transmitter circuit 140 to produce a corresponding RF signal from the RF transducer assembly 180 in the monitored region 195.

FIG. 9 is an example diagram illustrating an isolation circuit 900 according to embodiments herein.

In one embodiment, the isolation circuit 900 is a transmitter-receiver isolation circuit that is based on a single directional coupler 102. A directional coupler couples signals to different output ports depending on the direction of travel of signals through the main path of the directional coupler.

In a specific embodiment, the isolation circuit 900 includes a directional coupler with the coupling among the two output ports relative to the direction of travel of signals along the main

path of the directional coupler.

In normal operation, a directional coupler's “through input” port 104 is typically connected to the RFID reader's transmitter such as transmitter circuit 140. The “through output” port 108 is typically connected to an antenna associated with RF transducer assembly 180.

The “coupled forward” port 106 is typically terminated in a matched load resistance, for example a 50-ohm resistor, or a 50-ohm attenuator connected to a forward power sensor that measures transmitter power. The “coupled reverse” port 110 is then connected to the reader's receiver input port such as receiver circuit 150.

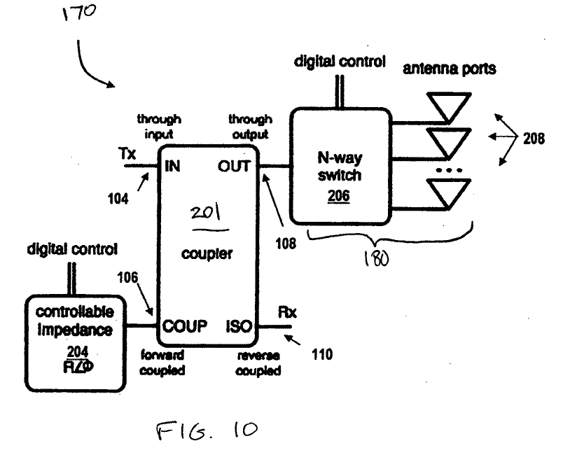

With reference to FIG. 10, another embodiment of an isolation circuit 900 is shown and described. The circuit includes a directional coupler 201, a configurable impedance circuit 204, a switch 206, and one or more antennas 208. The directional coupler 201 communicates with the configurable impedance circuit 204 via the couple forward port 106.

The switch 206 communicates with the directional coupler 201 via the through output port 108. The switch also receives input from a processing module to switch among the plurality of antennas 208.

In one embodiment, the directional coupler 201 is a 10 dB directional coupler part number XC0900A-10 manufactured by Anaren Microwave Inc. of East Syracuse, N.Y. In other embodiments other directional couplers having other coupling parameters are used. For example, a circulator or a 6-port coupler and above can also be used

The switch 206 can be an “N-way” switch, where N corresponds to the number of antenna elements 208 in communication with the switch 206. In other embodiments, N is fewer or greater than the number of antenna elements 208 communicating with the switch 206 (e.g., if one of the antenna elements 208 includes an array of elements). In one embodiment, the switch is part number MASW-007813MASW-007813, made by MA/COM of Burlington, Mass.

The antennas 208 associated with RF transducer assembly 180 can be any types of antenna elements. For example, the antenna elements 208 can be, but are not limited to, patch antennas, waveguide slot antennas, dipole antennas, and the like. Each antenna element 208 can be the same type of elements. Alternatively, two or more different types of antenna elements 208 can be used.

In some embodiments, one or more of the antenna elements 208 includes a plurality of antenna elements (i.e., an array of antenna elements). In some embodiments, the antenna elements 208 are multiplexed.

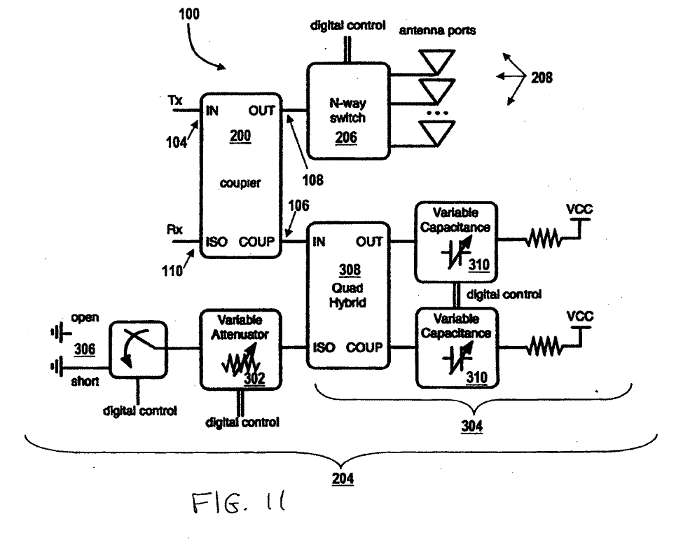

In one embodiment, the controllable impedance circuit 204 includes a variable attenuator, a variable phase shifter, and a reflective load such as an open or short circuit, which are described in more detail below with reference to FIG. 11. In other embodiments, additional or fewer components are included in the controllable impedance circuit 204.

As an operational overview and in one embodiment of operation, the controllable impedance circuit 204 is connected to the forward-coupled port 106 of the directional coupler so that the signal at the reverse-coupled port 110 can be affected by a reflection from the forward-coupled port 106. Thus a sampled portion of the transmitter's signal, varied in magnitude and phase by the controllable impedance circuit 204, can be reflected back into the coupler 201, which then reduces the amount of self-jammer energy present at the reverse-coupled port 110. Since the reader's receiver is connected to the reverse-coupled port 110, the self-jammer energy at the receiver input port can be controlled by adjusting the controllable impedance circuit 204.

With reference to FIG. 11, an embodiment of the controllable impedance circuit 204 is shown and described. The controllable impedance circuit 204 includes a variable attenuator 302, a variable phase shifter 304, and a reflective load 306 such as an open or short circuit.

In one embodiment, the variable attenuator 302 consists of a PIN diode attenuator, a gallium arsenide or silicon monolithic switched resistive attenuator, or any other variable attenuator. In a specific embodiment, the variable attenuator 302 consists of a switched monolithic attenuator part number DAT-15R5-PP available from Mini-Circuits Corp. of Brooklyn, N.Y. In another embodiment the variable attenuator 302 consists of a pair of PIN diodes, part number SMP-1304-011 available from Skyworks Solutions Inc. of Burlington, Mass., connected back-to-back in the a series attenuator configuration.

In operation, the variable attenuator 302 communicates with a digital control device, described in more detail below and receives commands from the digital control device. These commands cause the attenuator 302 to vary between a range of attenuation settings. For example, the attenuator 302 can have a granularity of 0.5 dB and 0 to 15 dB or greater. There is a tradeoff between level of cancellation and step size.

In one embodiment, the variable phase shifter 304 consists of a quadrature hybrid 308 connected to a pair of switched capacitor banks 310 implemented with either discrete components or an integrated circuit. In other embodiments the variable phase shifter 304 consists of a quadrature hybrid 308 connected to a pair of varactor diodes. In one embodiment the phase shifter consists of a quadrature hybrid 308 such as the XC0900P-03S hybrid coupler made by Anaren Microwave Inc. of East Syracuse, N.Y. The 0 degree and 90 degree ports of the hybrid coupler are each connected to a separate array of monolithic capacitors with values 0.5 pF, 1.0 pF, 2.2 pF, and 4.7 pF and switched by a gallium arsenide switch part number MASWSS0064 available from M/A-Com Inc. of Burlington, Mass.

In operation, the variable phase shifter 304 communicates with a digital control device, described in more detail below and receives commands from the digital control device. These commands cause the phase shifter 304 to vary among a variety of phase settings. For example, the phase shifter 304 is capable of approximately 200 degrees of controlled phase shift across the 902-928 MHz band. In another embodiment, the phase shifter 304 consists of 3 series sections and 2 stubs with quarter wavelength between each of the 5 sections.

In one embodiment, reflective load 306 consists of a gallium arsenide semiconductor switch that presents either a short circuit or an open circuit. In one embodiment this switch consists of a gallium arsenide switch part number MASWSS0192 available from M/A-Com Inc. of Burlington, Mass. This switch presents a 180-degree phase shift due to the change in reflectance between the open and short circuit.

When this phase shift is added to the approximately 200 degrees of phase shift available from the previously described phase shifter 304, an aggregate phase shift of greater than 360 degrees is available, which enables the controlled impedance to be placed at any rotation on a Smith Chart, which is also called the plane of complex impedance. In another embodiment, the reflective load 306 includes an open stub with a diode (pin or otherwise) short in front of it for the open short. Also, switched in values of L and C1 adders networks can also be used.

In operation, the reflect load 306 communicates with a digital control device, described in more detail below and receives commands from the digital control device. These commands cause the reflective load to vary between the open circuit configuration and the closed circuit configuration.

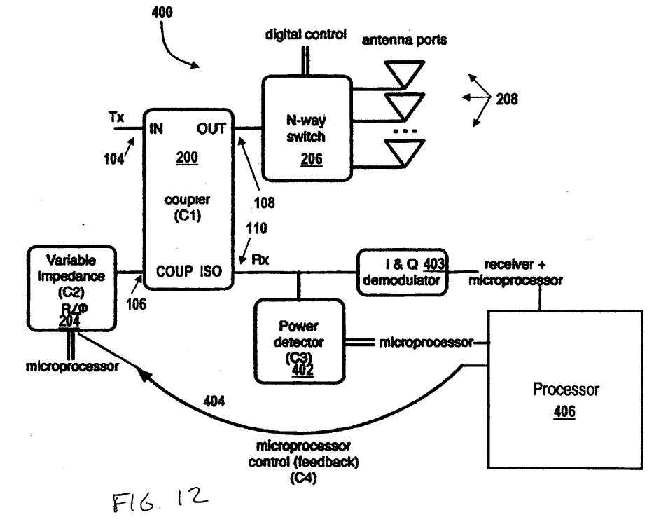

With reference to FIG. 12, one or more aspects of the disclosure are incorporated into the front-end circuitry of an RFID reader 400. The directional coupler 200 is shown as C1.

The variable impedance section 304 is shown as C2. An RF power detector 402 at the input of the receiver demodulator 403 is shown as C3. The feedback path 404 C4 is shown wherein the output of the receiver demodulator is sampled and fed to a microprocessor 406 implementing a control method described below in more detail.

In one embodiment, the microprocessor 406 is a DSP. In another embodiment, the microprocessor 406 is a field programmable gate array (FPGA). In another embodiment, one or more application specific integrated circuits (ASIC) are used. Also, various microprocessors can be used in some embodiments. In other embodiments, multiple DSPs are used along or in combination with various numbers of FPGAs. Similarly, multiple FPGAs can be used. In one specific embodiment, the microprocessor 406 is a BLACKFIN DSP processor manufactured by Analog Devices, Inc. of Norwood, Mass. In another embodiment, microprocessor 406 is a TI c5502 processor manufactured by Texas Instruments Inc. of Dallas Tex.

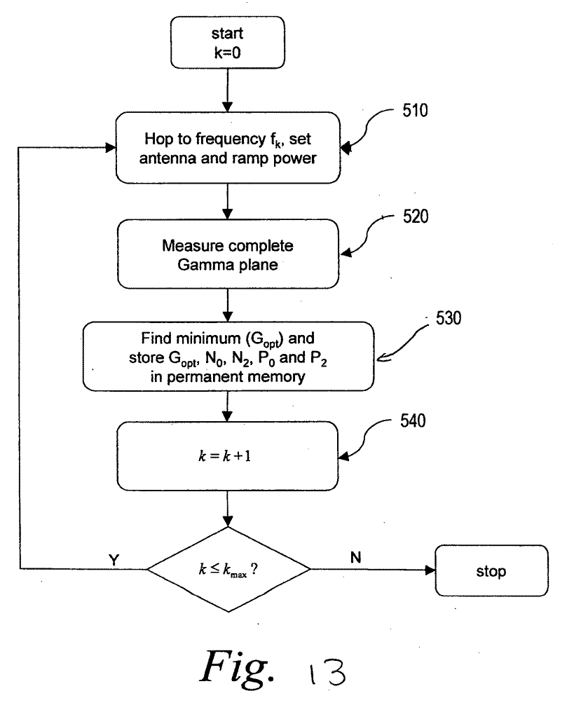

In operation, the feedback from the power detector 402 and demodulator 403 are presented to the microprocessor and used to automatically adjust the controllable circuit 204 to compensate for changes to the self-jammer level as the antenna, operating frequency, or local electromagnetic environment is changed. One method for adjusting the variable impedance is described below with reference to FIG. 13. This method may be implemented in dedicated logic hardware, in a state machine, in a microcontroller, or in software operating on a microprocessor.

With reference to FIG. 12, a method of finding a substantially optimal point on a curve is shown and described. For the parameters shown above, the function curve fit is N(G)=N₀+N₂|Gₒₚₜ−G|², N(G)≦N₀+12 dB, else N(G)=N₀+12 dB, where N is a curve fit function of the baseband noise level that best fits the measured data. In the previous equation, the G-Plane is a representation of the input impedance or load of a system. G=(Z_{L}−R₀)/(Z_{L}+R₀) where R₀ is the source impedance and Z_{L} is the load impedance.

In operation, the method includes hopping (step 510) to a frequency Fₖ, and then setting the antenna 204 and ramp power. At this setting, the components of the reader cooperate to measure (step 520) the gamma plane. Next, a minimum (i.e., Gₒₚ) is found (step 530) and GₒₚₜN₀, N₂, P₀ and P₂ are stored in memory, where P is a curve fit function of the power detection that best fits the measured data. The frequency is incremented (step 540) and the measurements are completed and stored again. This continues until the frequency reaches a maximum. In another embodiment, instead of incrementing the frequency it is decremented until it reaches a minimum value. Also, in other embodiments, the frequency is hopped and the order may be pseudo random, incremented/decremented as per local regulations.

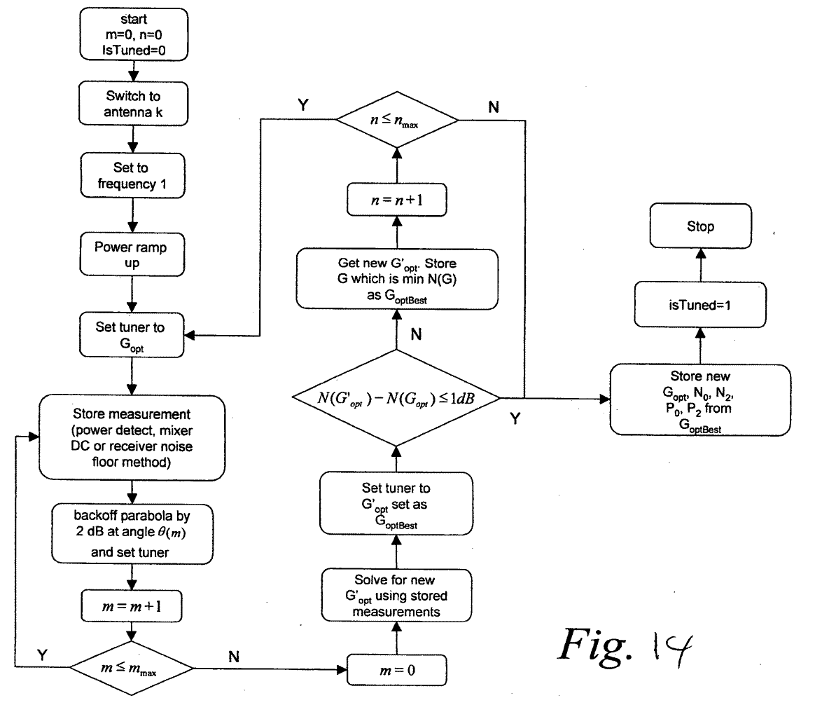

With reference to FIG. 14, an embodiment of a method for executing an algorithm to optimize the setting of the controllable impedance circuit 204 each time the reader hops frequency is shown and described. The m loop provides fine grain setting of tuner Gₒₚₜ. The n loop provides search across wider range when needed. During the m loop, data is collected at four or more points in the vicinity of the current guess of the optimum tune point. This data is expected to be in a parabolic portion of the tuner noise response. This is by virtue of having backed away from the current guess by 2 dB as determined by the current parameters that model the parabolic behavior. After collection of these data, they are used to calculate an updated estimate of for the parabolic behavior, and the minimum G for this new estimate is used as the new Gopt. With four data points, direct calculation may be used to find Gₒₚₜ, N0, and N2. For the case where more than four data points are collected various nonlinear estimation techniques may be used (such as Levenberg-Marquardt, or others). This new estimate is then verified by measurement and if it is within 1 dB of previously determined noise minimums it is assumed to be correct, and the flow chart terminates. If the new Gₒₚₜ estimate is not within 1 dB (parameterized) then it is possible that the optimum tuning has moved far way and the collected data is in the flat portions of the measurement surface. In this case a more global search across a wider range of the tuning range is undertaken and data is measured at Nₘₐₓ new G values.

After data collection of these Nₘₐₓ new values the measured noise values are scanned for minimum and this new minimum is assumed to be the new estimate of the optimum tuning

Using the circuitry and algorithms described above, there are multiple methods to automatically adjust the configurable impedance circuit 204 to compensate for changes to the self-jammer level. A first method is to examine the receive path noise floor. This is a direct method in the sense that it is a direct measure of one of the effects of the self-jammer noise that the tuner is trying to reduce. The tuning circuitry 204 is passive with respect to the RF signal path, so it does not contribute significant noise on its own, or increase the receiver noise floor. The minimization of the receive path noise floor therefore implies that the controlled impedance is properly adjusted. This noise floor may be measured by digitizing the receiver output with the reader's analog to digital converter(s) and measuring the amount of noise present in a frequency range free of tag responses.

A second method of detecting optimal adjustment of the controlled impedance circuit 204 is by examination of the RF power entering the receive signal path. When there are no interfering signals other than the self-jammer energy, the minimization of total energy present at the receiver input port represents an optimal adjustment of the controlled impedance. It has been observed that the substantial minimization of RF power on the receive path coincides with minimum receive path noise floor. When there are interfering signals present, it is usually the case that the amplitude of the interfering signal is small compared with the self-jammer signal. Thus a minimization of RF power on the receive path still provides an indication of correct adjustment. However, when large interferers are present the detected energy on the receive path provides only weak feedback on the quality of tuning because the self-jammer energy is dominated by the large interfering signal. This is because a wideband RF power measurement at the input of the receiver responds both to the self-jammer as well as any external interferers that may be present.

A third method of controlled impedance circuit 204 optimization is to examine the DC output component of a homodyne receiver's I/Q demodulator. For an ideal I/Q demodulator, when the DC component of both the I and Q demodulator outputs is zero, the tuning is substantially optimum. It has been observed that the minimization or receive noise floor corresponds with near-zero I and Q mixer DC voltage outputs. For a non-ideal demodulator, the controlled impedance circuit 204 adjustment is optimal when the demodulator's output DC component is the same as the inherent DC offset caused by the demodulator itself, for example due to any DC imbalance in the demodulator's internal mixer cells. In one embodiment, a monolithic demodulator, part number LT5575 manufactured by Linear Technology Inc. of Milpitas, Calif., has low inherent offset due to its monolithic construction. This offset and other DC offset sources are in general small compared with the DC values due to the self-jammer energy being measured, and can often be neglected. Alternately the offset may be included as an overall measurement offset. This offset can be stored in a non-volatile memory, for example during a factory calibration, and can be subtracted from measured values obtained during controlled impedance adjustment if this third method of detecting optimal adjustment is employed.

This third method provides two signed numbers (sign+magnitude) to assist in locating the optimal adjustment. The first and second methods provide a single unsigned scalar, the minimum of which constitutes best adjustment. For the previous two methods, direction of adjustment toward an optimum is determined by making small steps in one or more of the controlled impedance circuit 204 parameters (attenuation, phase, and reflection switch) and examining the derivative of the measure. With the third method, the signed numbers, and the fact that there are separate numbers for the demodulator's I mixer and Q mixer outputs provide additional information useful for the controlled impedance adjustment. Also in the vicinity of the optimum tuner setting, the I and Q mixer responses are approximately orthogonal (i.e. movement in the correct direction only affects I, and movement in the perpendicular direction only effects Q). Mixer tuning can be achieved by simply following the correct direction for first one mixer to adjust its output to zero and then adjust in a perpendicular direction to adjust the other output also to zero. This doesn't require more complex nonlinear optimizations of the previous block diagram, and can be achieved by simply following two gradients to zero. Alternatively, as with FIG. 5 and FIG. 6, the tuner may be adjusted across all settings to find setting that brings the I mixer and Q mixer outputs to zero, thus achieving the tuned condition.

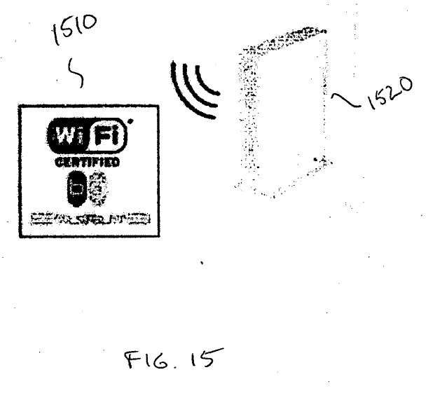

FIG. 15 is an example diagram including a wireless RFID tag and an access point according to embodiments herein.

One embodiment herein includes an integrated circuit that includes a WiFi radio and an RFID radio that operates at one or more frequencies such as 2.4 GHz, 900 Mhz, etc. The integrated circuit can be a wireless system on a chip (SOC). The integrated circuit can be configured to read tags, which are operable (e.g., resonant) at 2.4 GHz or a combination of 900 MHz and 2.4 GHz, etc.

One objective herein is to allow a number of household items to join a wireless network system that have been installed in a home. Currently, WiFi is difficult to implement in laptops for non-experts with WiFi SSIDs, security type, security keys, DHCP/manual addressing setup, etc. The situation is going to be much more difficult for new devices that will appear in homes due to UI issues: Big screen televisions, HD DVD players, game consoles, Skype/VOIP phones, cameras, printers don't have keyboards or mice.

One solution, outlined here, is to use a tag to transfer digital setup information physically for zero-configuration networking where all networking and security information is provided in the tag. If information has been previously entered incorrectly, the information in a tag can override a user's laptop to ensure immediate and proper operation. The sequence for operation in a household example is as follows:

By bringing an un-initialized tag near a WiFi access point (AP) 1520, the combination WiFi/RFID chip in the access point can be used to load configuration information in a tag in a time such as less than 100 ms.

In one embodiment, all of the security and network configuration information can be transferred into a physical token. The tag 1510 could be supplied with the AP (factory programmed) or purchased separately in a tag pack. Another option is that a store service has a trained technical assistant who creates a personalized tag for a particular customer that can be used in their home only.

All configuration for the customer's home network could be obtained at time of purchase. In all cases, this RFID function leverages from the existing RFID industry where a tag costs less than $0.010, making the incremental cost in tag very low. One way to produce a low-cost SOC (e.g., system network chip including WIFI and RFID tag reader) is outlined later in this document.

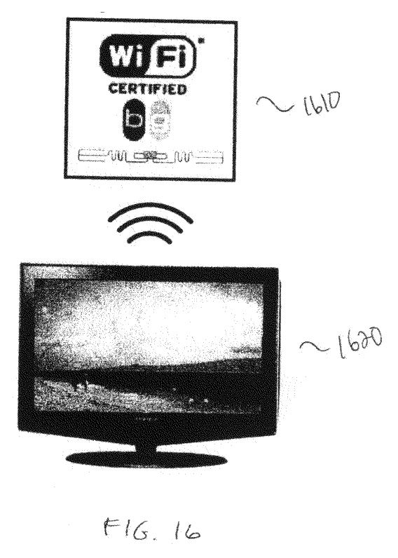

FIG. 16 is an example diagram illustrating a tag 1610 in proximity to a device 1620 according to embodiments herein. By bringing the (configured) tag 1610 near a wireless device 1620 (e.g., a computer system) which has the same or similar wireless SOC including an RFID tag reader, the device 1620 will read the contents of the tag, and transfer those contents to the WiFi radio subsystem and the operating system to configure and notify the system of the changes.

Accordingly, the device 1620 reading the tag 1610 can be configured automatically based on the information retrieved from the tag 1610.

There are possible variants of what subsystem informs the other and in what order those events occur. The wireless SOC could manage all setup information in both networking and security itself and inform the operating system afterwards or could forward information to the operating system which could then decide how it was going to pass information back to the wireless SOC.

The system shown in this example is a television, where a cumbersome process of entering information on a wireless remote control (often without alpha entry) presents a user interface problem that is easily solved with a physical token from the RFID system. This technique can be used in other applications as well.

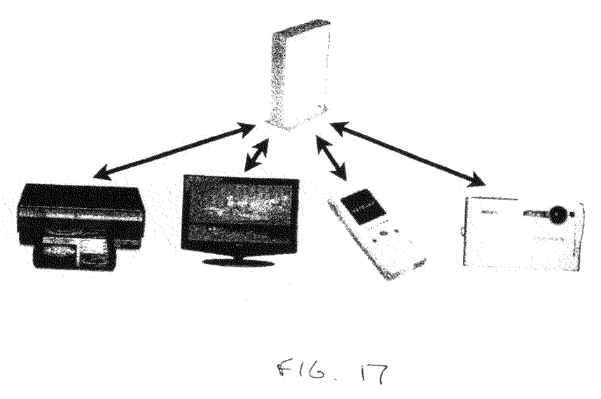

FIG. 17 is an example diagram illustrating an access point and a number of devices in a monitored region according to embodiments herein.

One benefit of this approach is that the incremental work for each device that has this wireless SOC is the same as the first one, without requiring the user to learn the UI of every device and re-key the same information. The UI of these devices can vary depending on form factor and cost profile of the device. The device that is generally the easiest to configure is a computer in notebook or desktop form due to an extensive HW/SW UI associated with most computer notebooks and desktops. Most portable and many desktop computers contain WiFi and Bluetooth radios included in their design and could obviously be added to this “one step” configuration using this wireless SOC containing RFID.

The new Bluetooth standard 2.1+EDR is combining NFC (13.56 MHz technology) with Bluetooth to accomplish a very similar purpose. In this Bluetooth case, at 13.56 MHz tag is used to store the address and passkey information of a particular Bluetooth device. In the cellular GSM/3G context, a network password could be provided, or authentication certificates for downloading content, payment information could be provided. One extension of embodiments herein can include a tag that is semi-passive or active. This may be useful if there was going to be a button on the tag that required human touch, a sound output device (buzzer), display or for novel applications such as a wallet/key finder.

A method of configuration can be very important in many user scenarios, especially when people nearby an owner of the tag should not have access to information in the tag. An example is a coffee shop where one would like to be able to provision a number of laptops or WiFi-enabled cell phones without creating an open network or sharing private information. When a user purchased a coffee at a register, they could get their receipt on an RFID tag which could be used to obtain internet access by reading contents of the tag to access the internet. Access can have an associated expiration time or be used as a loyalty program or simply to allow consumers to buy digital access with cash, debit or credit.

If the information is not of the type that can be used to reconfigure the radio, the information is forwarded to the controller for interpretation. One form of interpreting this information could be to treat it as a URL, which contains a pointer to an arbitrary piece of information in an online or local program. Some other examples including use of URLs

1. DVD media. An online service such as Netflix could send a user a cover album of a HD disc which would simply contain a tag which has a URL to an online store, maintaining their current business model (using time through a postal service to regulate flow of bits as opposed to pay per use). Alternatively, a printer company could sell tagged paper which could be encoded with the URL and then the media cover art could be printed on the paper for later use. The paper could be more expensive than normal, containing a “media tax” to be sent to the content/copyright owner.

2. CD media. An online service such as iTunes could allow users to print out cover albums for music they purchased. A user could simply bring this cover art near an entertainment center to play their media and take it away when they are done.

3. Photo Albums. A user could print out a photo which represents a group of photographs. By bringing the photograph near their media center, the photo album would be displayed from local or online content. If more than one photo tokens was placed near the media center, then the album that would be played would be the concatenation of the multiple ‘photos’.

4. IP phone calling. A user could print out photos of their friends and family. Rather than trying to use a remote to type in a number into a television or entertainment center, the user could bring the photo near their device and immediately initiate a phone or video call.

TinyURL for RFID tags can be stored in the tags such as one or more of remote devices 192. A URL can contain, in principle, an infinite amount of information (they are of unbounded Unicode length). On the other hand, the number of things an infinite number of URLs can point to is finite and is much less than the number of bits contained in an RFID tag (96 bits-3 kbits today for a UHFGen2 tag). Therefore, a look-up service can be used, which will take any URL and make a 64-bit hash (16 billion-billion unique entries)+a 32-bit IP address.

A method for allowing a human to indicate an interest is required. i.e. if these tokens are lying around in your house, you may want someone to be able to indicate which one they want with some kind of switch on the tag. A membrane switch or capacitive load, which requires input such as human contact to work properly, are examples.

Note again that techniques herein are well suited for enabling multiple communication modes using at least a portion of shared circuitry. However, it should be noted that embodiments herein are not limited to use in such applications and that the techniques discussed herein are well suited for other applications as well.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. A circuit comprising:
an input to receive an RF mode control signal;
multiple ports; and
path circuitry disposed between the multiple ports, the path circuitry configured to create conductive paths between the multiple ports depending on a state of the RF mode control signal.

2. The circuit as in claim 1, wherein the multiple ports includes:
a first port coupled to an output of a transmitter circuit;
a second port coupled to an input of a receiver circuit; and
a third port for coupled to an RF transducer assembly.

3. The circuit as in claim 2, wherein the path circuitry is configured to, in a first mode when specified by the RF mode control signal, simultaneously produce: i) a conductive path between the transmitter circuit and the RF transducer assembly, and ii) a conductive path between the RF transducer assembly and the receiver circuit.

4. The circuit as in claim 2, wherein the path circuitry is configured to, in a second mode when specified by the RF mode control signal, toggle between sub-modes of: i) providing a conductive path between the transmitter circuit and the RF transducer assembly, and ii) providing a conductive path between the RF transducer assembly and the receiver circuit.

5. The circuit as in claim 4, wherein the sub-modes are non-overlapping in time such that the path circuit does not enable the conductive path between the transmitter circuit and the RF transducer assembly and the conductive path between the RF transducer assembly and the receiver circuit at the same time.

6. The circuit as in claim 2, wherein the transmitter circuit includes a modulator in communication with a baseband bus circuit;
wherein the receiver includes a demodulator in communication with the baseband bus circuit.

7. The circuit as in claim 6, wherein the baseband bus circuit is coupled to a first baseband processing module and a second baseband processing module, the first baseband processing module configured to manage communications with RFID tags, the second baseband processing module configured to manage half-duplex communications.

8. The circuit as in claim 7, wherein the half-duplex communications includes at least one of: Bluetooth communications, 802.11 communications, WiMax communications and cellular phone communications.

10. The circuit as in claim 1, wherein the multiple ports includes a first port coupled to a transmitter and a second port coupled to a receiver, the circuit further comprising:
an RF isolation circuit configured to reduce coupling of a signal from the first port and the second port.

11. The circuit as in claim 3 further comprising:
an RF isolation circuit configured to reduce coupling between the transmitter circuit and the receiver circuit during the first mode when the conductive path between the RF transducer assembly and the receiver circuit enables the receiver circuit to monitor a region for a presence of RF energy and the conductive path between the transmitter circuit and the RF transducer assembly enables the transmitter to produce an RF signal for transmission in the region.

12. A circuit comprising:
an input to receive a mode control signal;
multiple ports; and
switch circuitry disposed between the multiple ports, the switch circuitry configured to enable a full-duplex RF mode and a half-duplex RF mode depending on a state of the mode control signal.

13. The circuit as in claim 12, wherein the multiple ports includes:
a first port coupled to an output of a transmitter circuit;
a second port coupled to an input of a receiver circuit; and
a third port for coupled to an RF transducer assembly.

14. The circuit as in claim 12, wherein the switch circuitry is configured to create electrical paths between the RF transducer assembly and the transmitter circuit and receiver circuit depending on a state of the mode control signal.

15. The circuit as in claim 12, wherein the switch circuitry includes path circuitry disposed between the multiple ports, the path circuitry providing connectivity amongst the multiple ports depending on the state of the mode control signal.

16. A method comprising:
receiving mode selection input; and
configuring a circuit to one of a full-duplex mode and a half-duplex mode depending on a mode as specified by the mode selection input.

17. The method as in claim 16, wherein configuring the circuit includes:
in response to detecting that the mode selection input specifies the full-duplex communication mode, configuring the circuit in accordance with the full-duplex mode to enable communication between the circuit and at least one RFID tag; and
in response to detecting that the mode selection input specifies the full-duplex mode, configuring the circuit in accordance with the half-duplex mode to enable communication between the circuit and at least one remote device based on at least one of: a Bluetooth communication protocol, an 802 communication protocol, a WiMax communication protocol, and a cellular phone protocol.

18. The method as in claim 16, wherein configuring the circuit to the full-duplex mode includes:
simultaneously enabling a transmitter circuit to electrically drive a transducer assembly to generate an RF signal while enabling a receiver circuit to receive an electrical signal produced by the transducer as a result of the transducer assembly detecting presence of an RF signal in a monitored region.

19. The method as in claim 16, wherein the generated RF signal is a continuous wave output transmitted by the transducer assembly in the monitored region to power at least one RFID tag in the monitored region; and
wherein the RF signal in the monitored is a response generated by the at least one RFID.

20. The method as in claim 16, wherein configuring the circuit to the half-duplex mode includes:
switching between a.) electrically coupling a receiver circuit to a transducer assembly to receive an RF signal present in a monitored region and b.) electrically coupling a transmitter circuit to a transducer assembly to produce an RF signal in the monitored region.

21. The method as in claim 16, wherein receiving the mode selection input includes:
receiving the mode selection input from a scheduler, the scheduler specifying different communication modes in which to configure the circuit based on a mode control schedule.

22. The method as in claim 16, wherein receiving the mode selection input includes:
receiving first input to control connectivity between a transducer device and transmitter circuit and first switch circuit; and
receiving second input to control a second switch circuit.

23. The method as in claim 16 further comprising:
maintaining a first port of the circuit to receive an input signal from a transmitter circuit;
maintaining a second port of the circuit to drive an output signal to a receiver circuit;
maintaining a third port of the circuit to couple to an RF transducer assembly; and
initiating selective electrical coupling of the RF transducer assembly through the circuit to the first port and the second port depending on the received mode selection input.

24. The method as in claim 23, wherein initiating selective electrical coupling of the RF transducer assembly through the circuit to the first port and the second port depending on the received mode selection input includes:
in response to detecting that the mode selection input specifies the full-duplex mode, initiating activation of switch circuitry in the circuit to simultaneously configure the circuit to include:
i) a first electrical path between the transducer assembly and the receiver, the first electrical path conveying a corresponding electrical signal produced by the RF transducer assembly in response to the RF transducer assembly detecting presence of an RF signal in a monitored region, and
ii) a second electrical path between the transmitter and the transducer assembly, the second electrical path enabling the transmitter to produce a corresponding RF signal from the RF transducer assembly in the monitored region.

25. The method as in claim 23, wherein initiating selective electrical coupling of the RF transducer assembly through the circuit to the first port and the second port depending on the received mode selection input includes:
in response to detecting that the mode selection input specifies the half-duplex mode, initiating activation of switch circuitry in the circuit to switch between:
i) configuring the circuit to include a first electrical path between the transducer assembly and the receiver, the first electrical path conveying a corresponding electrical signal produced by the RF transducer assembly in response to the RF transducer assembly detecting presence of an RF signal in a monitored region, and
ii) configuring the circuit to include a second electrical path between the transmitter and the transducer assembly, the second electrical path enabling the transmitter to produce a corresponding RF signal from the RF transducer assembly in the monitored region.
